(19) United States
(12) Patent Application Publication
(10) Pub. No.: US 2020/0355340 A1
(43) Pub. Date: Nov. 12, 2020

(54) WARNING LIGHT FOR BLIND AREA OF LANE CHANGE

(71) Applicant: Magna Mirrors (Taicang) Automotive Technology Co., Ltd., Jiangsu (CN)

(72) Inventors: Jun Wu, Jiangsu (CN); Fengjie Zhen, Jiangsu (CN); Gang Shen, Jiangsu (CN); Zhongyin Shen, Jiangsu (CN)

(21) Appl. No.: 16/583,933

(22) Filed: Sep. 26, 2019

(30) Foreign Application Priority Data
May 9, 2019 (CN) 201920658503.6

(51) Int. Cl. F21S 43/31

(52) U.S. Cl. CPC F21S 43/31; F21W 2103/25

(57) ABSTRACT

A warning light for blind area of lane change is provided that includes a housing having an opening for providing a light exiting surface and a receiving cavity; a circuit board disposed in the receiving cavity of the housing, the circuit board has at least one light source disposed toward the light exiting surface such that the at least one light source emits light toward the light exiting surface; and at least one reflecting panel disposed between the light source and the light exiting surface for reflecting stray light in light emitted from the at least one light source to the light exiting surface. The warning light for blind area of lane change can remind the driver of the vehicle rear side by emitting an optical signal to improve driving safety, and has simple assembly, simple structure, ingenious design, and high light utilization rate.

### FIELD OF THE INVENTION

The present relates to the technical field of automobile parts, in particular to an automobile lamp, especially to a warning light for blind area of a lane change.

### BACKGROUND OF THE INVENTION

With the development of the times and the advancement of technology, automobiles are more than just a means of transportation. Consumers' demands for the comfort and safety of automobiles are gradually improving. Due to the limited field of view of the rearview mirror and the blind area of the visual field, the probability of accidents is increased when other vehicles appear in the blind spot of the visual field. In the existing warning device for lane change, the light source is set back toward the target direction, and the aluminum housing facing the light exiting direction reflects the light to the target area. However, due to the limitations of the reflective design structure of the product itself, the light utilization rate is not high, and the brightness cannot meet the driver's requirements, thereby affecting the driving experience of the consumer. Moreover, the product has high requirements on the precision of the aluminum housing process, the quality control of the product is difficult, and the product cost is high.

### SUMMARY OF THE INVENTION

The aim of this invention is to overcome the deficiencies the existing technology mentioned-above comprised, and to provide a warning light for blind area of lane change that is simple in assembly, simple in structure, clever in design, high in light utilization, can meet the ever-increasing brightness and uniformity requirements of the lamps, and can also meet the customer's aesthetic requirements.

In order to realize the above aims, the warning light for blind area of lane change according to the present invention comprising:

a housing having an opening for providing a light exiting surface and a receiving cavity;

a circuit board disposed in the receiving cavity of the housing, the circuit board comprises at least one light source disposed toward the light exiting surface such that the at least one light source emits light toward the light exiting surface; and

at least one reflecting panel disposed between the light source and the light exiting surface for reflecting stray light in light emitted from the at least one light source to the light exiting surface.

Preferably, the housing is an opaque plastic housing.

Preferably, the reflecting panel is provided with a plurality of reflecting surfaces, when the light emitted from the at least one light source passes through the reflecting panel, the plurality of reflecting surfaces reflect the stray light to the light exiting surface.

Preferably, the reflecting surface is integrated with the housing.

Preferably, the opening of the housing is provided with a bonding member for covering the opening, the bonding member is provided with a hollowed-out area to provide the light exiting surface, the housing is adhered to a mirror body of a rear view mirror by the bonding member, so that the light emitted from the light source comes out of the mirror body of the rearview mirror through the light exiting surface.

Preferably, the bonding member comprises a first surface bonded to the housing and a second surface bonded to the mirror body of the rear view mirror.

Preferably, the hollowed-out area has a preset profile.

The warning light for blind area of lane change according to the present invention can remind the driver of the vehicle rear side by emitting an optical signal to improve driving safety, and has simple assembly, simple structure, ingenious design, high light utilization rate, and can meet the ever-increasing brightness and uniformity requirements of the lamps, and can also meet the customer's requirements for the appearance of the vehicle.

### BRIEF DESCRIPTION OF THE DRAWINGS

FIG. 1 shows an exploded view of a first embodiment of a warning light for blind area of lane change according to the present invention.

FIG. 2 shows a front view of a first embodiment of a warning light for blind area of lane change according to the present invention.

FIG. 3 shows a cross-sectional view taken along line A-A in FIG. 2.

FIG. 4 shows a schematic structural view of a second embodiment of a warning light for blind area of lane change according to the present invention.

Reference numeral as follows:
1 bonding member
2 reflecting panel
3 circuit board
4 housing
5 hollowed-out area
6 reflecting surface
7 light source

### DETAILED DESCRIPTION OF THE INVENTION

In order to understand the technical content of the present invention clearly, the present invention is further exemplified by reference to the following example.

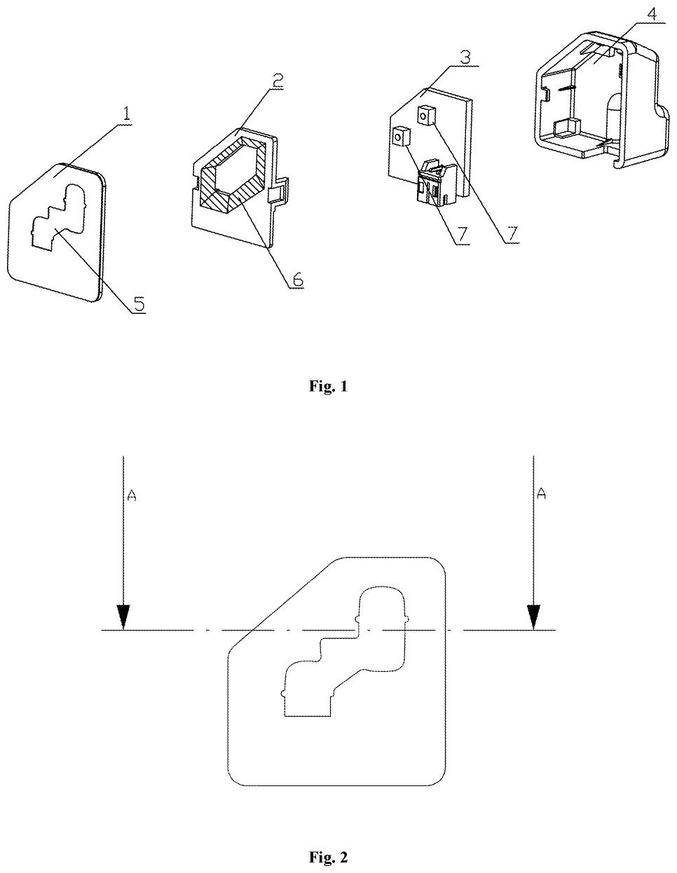

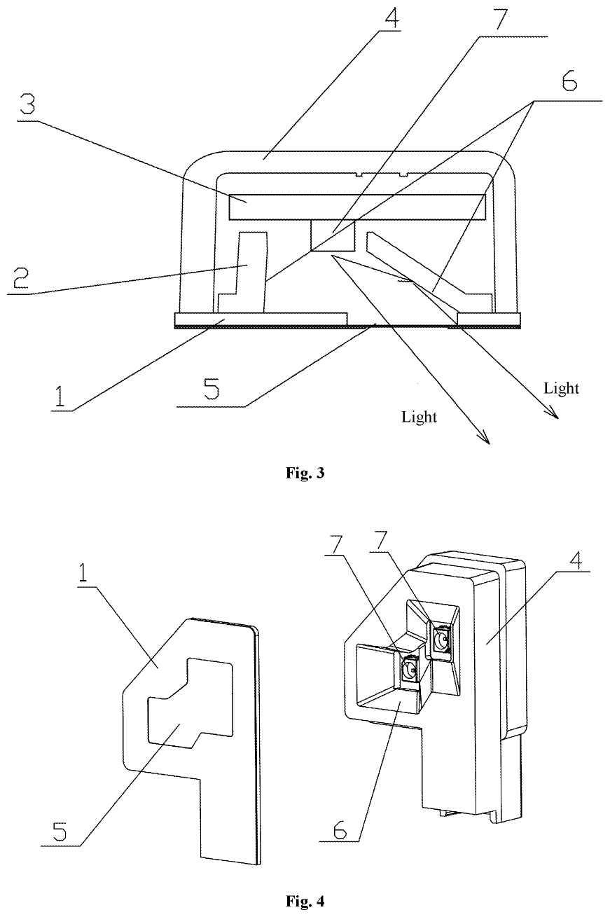

FIGS. 1 to 4 shows an example of a warning lamp for blind area of lane change according to the present invention, comprising: a bonding member 1, provided with a hollowed-out area 5 having a preset profile; a reflecting panel 2 provided with a plurality of reflecting surfaces 6; a circuit board 3 provided with two light sources 7, the circuit board is fixed within the housing 4 by a buckle or the like; a housing 4 having an opening for providing a light exiting surface and a receiving cavity for receiving the circuit board and the reflecting panel.

When the light emitted by the two light sources 7 passes through the reflecting panel 2, the plurality of reflecting surfaces 6 reflect the stray light to the light exiting surface, thereby improving the uniformity of the light and increasing the brightness of the light.

In the warning light for the blind area of the lane change according to the present invention, the light is emitted from the light source 7 on the circuit board, and then reflected by the reflecting surface 6 of the reflecting panel to form the warning light for warning the driver. As an example of the warning lamp for the blind area of the lane change, the housing is adhered to the inner mirror body of the rearview mirror by the bonding member 1, so that the light emitted from the light source comes out of the transparent mirror body of the rearview mirror through the light exiting surface to form the warning light visible to the driver.

As shown in FIGS. 1 to 4, two LED light sources 7 are disposed on the circuit board 3. A part of the light emitted from the LED light source directly illuminates the target area of the light exiting surface, the remaining light (stray light) is reflected by the reflective surface 6 and then also illuminates on the target area of the illuminating surface. The present invention does not limit this, and other number and color LED light sources can be set according to actual conditions.

FIGS. 1 to 4 show the outline of the warning light housing 1, but the outline of the housing 1 is not unique, and can be designed into other styles according to requirements.

In an embodiment of the warning light for blind area of lane change according to the present invention, the housing is an opaque plastic member.

In an embodiment of the warning light for blind area of lane change according to the present invention, the reflecting surface 6 can be integrated with the housing.

In an embodiment of the warning light for blind area of lane change according to the present invention, the housing is adhered to the mirror body of the rearview mirror by the bonding member 4 comprising a first surface bonded to the housing and a second surface bonded to the mirror body of the rear view mirror. The bonding member 4 can be a double-sided adhesive tape.

In an embodiment of the warning light for blind area of lane change according to the present invention, the bonding member is provided with a hollowed-out area 5 having a preset profile. The hollowed-out area 5 is configured to transmit the light emitted from the internal light source and the light reflected by the reflective surface. The profile of the hollowed-out area is not unique, and may be determined according to actual conditions.

The warning light for blind area of lane change according to the present invention can remind the driver of the vehicle rear side by emitting an optical signal to improve driving safety, and has simple assembly, simple structure, ingenious design, high light utilization rate, and can meet the ever-increasing brightness and uniformity requirements of the lamps, and can also meet the customer's requirements for the appearance of the vehicle.

In the present specification, the present invention has been described according to the particular embodiments. But it is obvious that these embodiments can be modified or changed without departure from the spirit and scope of the present invention. Therefore, the specification described above is exemplary only and not intended to be limiting.

1. A warning light for blind area of lane change, comprising:
a housing having an opening for providing a light exiting surface and a receiving cavity;
a circuit board disposed in the receiving cavity of the housing, the circuit board comprises at least one light source disposed toward the light exiting surface such that the at least one light source emits light toward the light exiting surface; and
at least one reflecting panel disposed between the light source and the light exiting surface for reflecting stray light in light emitted from the at least one light source to the light exiting surface.

2. The warning light for blind area of lane change according to claim 1, wherein the housing is an opaque plastic housing.

3. The warning light for blind area of lane change according to claim 1, wherein the reflecting panel is provided with a plurality of reflecting surfaces, when the light emitted from the at least one light source passes through the reflecting panel, the plurality of reflecting surfaces reflect the stray light to the light exiting surface.

4. The warning light for blind area of lane change according to claim 1, wherein the reflecting surface is integrated with the housing.

5. The warning light for blind area of lane change according to claim 1, wherein the opening of the housing is provided with a bonding member for covering the opening, the bonding member is provided with a hollowed-out area to provide the light exiting surface, the housing is adhered to a mirror body of a rear view mirror by the bonding member, so that the light emitted from the light source comes out of the mirror body of the rear view mirror through the light exiting surface.

6. The warning light for blind area of lane change according to claim 5, wherein the bonding member comprises a first surface bonded to the housing and a second surface bonded to the mirror body of the rear view mirror.

7. The warning light for blind area of lane change according to claim 5, wherein the hollowed-out area has a preset profile.

8. The warning light for blind area of lane change according to claim 3, wherein the reflecting surface is integrated with the housing.
